(19) United States
(12) Patent Application Publication
(10) Pub. No.: US 2017/0046489 A1
(43) Pub. Date: Feb. 16, 2017

(54) HEALTHCARE AND FERTILITY EXCHANGE APPLICATION FOR ELECTRONIC DEVICES

(71) Applicant: Jesse HADE, Scottsdale, AZ (US)

(72) Inventor: Jesse HADE, Scottsdale, AZ (US)

(21) Appl. No.: 15/218,726

(22) Filed: Jul. 25, 2016

Related U.S. Application Data
(60) Provisional application No. 62/205,130, filed on Aug. 14, 2015.

(51) Int. Cl. G06F 19/00; G06Q 30/08; H04L 29/08

(52) U.S. Cl. CPC G06F 19/327; H04L 67/306; G06F 19/3406; G06F 19/322; G06Q 30/08

(57) ABSTRACT

Generally, there is a computer implemented system and method for an electronic health matching and health services exchange. The health services exchange may have three main components or modules: a match-making functionality, a health services exchange, and a module to assist in streamlining the medical processes. The match-making functionality may allow for the matching of donors/recipients/gestational carriers and surrogates/medical centers for the purpose of creating profiles enabling the donation or reception of eggs from female individuals. Further, the health exchange enables the bidding of and for these services by enabling users to anonymously enter a health marketplace where solicitations made by users, medical treatment providers, etc. may be viewed and selected. The medical transaction module can be used to create virtual cards, such as an insurance card, to use for payment of medical services. The combination of which streamlines the medical process and creates a transparent and competitive medical marketplace.

### CLAIM OF PRIORITY

This application claims the priority of U.S. Ser. No. 62/205,130 filed on Aug. 14, 2015, the contents of which are fully incorporated herein by reference in its entirety.

### FIELD OF THE EMBODIMENTS

The field of the embodiments of the present invention relate to a web or mobile based application that enables information, decision-making, and a health exchange for medical, dental, radiologic and alternative healthcare related services including but not limited to fertility care and services such as medications and medical procedures. In particular, the present invention brings together service providers and consumers, amongst others, to enable price negotiations in a competitive, yet informed, decisions to be made pertaining to an individual's medical or health related needs.

### BACKGROUND OF THE EMBODIMENTS

Typically medical services are received at a medical facility such as a treatment center, hospital, or the like. In order to receive such services, depending on if the individual has insurance, the cost to a user may vary greatly. Further, the particular geographic location of the user may also largely influence the associated cost of receiving a medical service. Managing medically related business is becoming exponentially more challenging, particularly in light of recent legislative changes to the healthcare system as a whole.

Many insurances companies have placed strict caps on compensation for patients seeking or in need of medical services such as surgery, MRIs, CAT scans, medical testing, and the like. However, operating expenses for these institutions remain at an all-time high. Further, a lack of transparency further puts potential patients at a loss as to whether they are saving money by taking one particular action or another.

Thus, there is a need for a system and method to help ensure operating expenses are met, yet still create a competitive pricing market by which potential users or patients can actively negotiate a price that they can afford to receive their medical, dental, radiologic or alternative health related needs and care or donate biological material (eggs, sperm, embryos, etc.) and negotiate a compensation therefor directly with the recipient of such material.

Further, recipients of biological material can be paired up with potential donors and/or gestational carriers and surrogates at various medical institutions via a competitive bidding process to ensure people's needs can be met in a cost effective manner. The users of such a system will also be privy to who is offering what treatment or health related service once the negotiated price is accepted by one or more provider/vendors. This will allow users a chance to receive the necessary care and services they would otherwise not be able to afford in the current marketplace. The present invention and its embodiments meet and exceeds these objectives. Review of related technology:

U.S. Pat. No. 8,670,993 pertains to an internet-based competitive pricing and bidding transaction system that includes one or more transaction processing servers that interface and communicate over the internet with client computer systems of prospective online consumers, medical and professional/licensed services providers and a plurality of related information databases. The transaction processing system handles online communications and procedures for conducting auctions for delivery of proffered medical and professional/licensed services and maintains a registration database of service providers and online prospective consumers/bidders. Medical and professional/licensed services providers may include licensed doctors/nurses, licensed veterinary doctors/technicians as well as conventional homecare/hospice providers, physical therapy providers, babysitting and other professional caretaker services that can provided to/for man or animal. The online proffered services may include conventional medical treatment and/or veterinary services provided for animals, pets or other creatures. A professional license authentication/qualifier engine is provided which transparently and automatically researches, verifies and updates professional credentials, accreditations and background information of each professional service provider upon registration of that service provider with the transaction system, and makes that information available to prospective registered bidders online.

U.S. Pat. No. 8,489,421 pertains to a health care cost management marketplace that brings together health care payers and health care cost management vendors. The health care cost management vendors bid on lots of single-claims or multiple claims. Health care cost reduction contracts are awarded to vendors whose bids project the greatest net health care cost reduction savings. Auctions are timed and vendors may change their bids while time remains. Bids include a vendor fee percentage, and, for single claim lots, may further include an estimated cost savings amount. For the single-claim lots, vendors which fail to achieve actual cost reduction savings above a predetermined threshold compared to estimated savings can be penalized.

U.S. Pat. No. 7,765,146 pertains to a medical cost adjusting method for suppressing a medical cost to a reasonable price so that a person who suffers from a disease can receive an appropriate medical service even if the person is not insured. A medical institution presents a predicted medical cost to be demanded therefrom for a medical service given to a patient as a desired demanding amount and, on the other hand, the patient, who desires to receive the medical service, presents a payable medical cost as a desired medical treatment amount, thus, matching of the desired demanding amount to the desired medical treatment amount is carried out.

Accordingly, it is possible of integrating a reverse auction and a regular auction making it possible of efficiently collect members concerned in the auction trade. In the reverse auction, a medical cost is used as an article of trade between a medical institution and a patient. That is, the integrated auction according to the present invention is an auction structure between members wherein a demand for an article of trade is attempted to meet a supply of the same, and this brings about a condition where there is a high possibility of making a successful bid and an effect of markedly reducing a medical cost as compared to a conventional medical cost.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

Generally, the present invention and its embodiments provide for an electronic health services exchange. The health services exchange has at least three main components: a match-making functionality, a health services exchange, and a module to assist in streamlining general medical processes. In some embodiments, more or less of these functionalities may be contained in any one embodiment. The match-making functionality may allow for the matching of donors/recipients/gestational carriers/surrogates/medical centers for the purpose of creating profiles enabling the donation or reception of eggs, sperm, and/or embryos from individuals or couples. Certain individuals may be able to find donation centers and donate their eggs, sperm, and/or embryos for a sum of money or other form of compensation. Further, intended recipients will be able to find and contact, either individuals or donation centers, directly and anonymously for purposes of receiving donated eggs for their own fertility needs.

Once a donation has been received, a user may use the system, preferably a web or mobile application, in order to track appointments, medications, and instructions for treating various fertility issues. There may be videos and information available to the user to help them improve their own natural fertility thereby increasing their chances for conception.

Further, the health exchange enables the bidding and price negotiation of and for these services by enabling users to anonymously enter a health marketplace where solicitations made by users, medical treatment providers, etc. may be viewed and selected. Real time bidding and price negotiation for services, such as fertility services, may occur thereby creating competition in the marketplace and providing the users with competitive and potentially local pricing they may have not previously had access. The medical transaction module can be used to create virtual cards to use for payment of medical services as well as virtual insurance cards thereby ensuring a user always has the requisite information to provide to a medical service provider and the insurance carrier itself as a means to verify benefits and payments. In some embodiments, updates to insurance can be automatically pushed to the user profile.

In one embodiment of the present invention, there is a method of providing an electronic health cost adjustable marketplace, the method comprising the steps of: providing a first electronic device in communication with a server via a first communication network, the first electronic device having a computer readable storage medium storing one or more programs for execution by one or more processors, wherein the one or more programs has instructions for providing a cost adjustable marketplace application to a wired or wireless device, and wherein the first electronic device is accessed by at least one patient; providing a second electronic device in communication with the server via a second communication network, the second electronic device having a computer readable storage medium storing one or more programs for execution by one or more processors, wherein the one or more programs has instructions for providing a cost adjustable marketplace application to a wired or wireless device, and wherein the second electronic device is accessed by at least one medical institution; the at least one patient placing at least one bid via the first electronic device for a healthcare related service with the bid to be provided to the at least one medical institution, wherein the identity of the at least one medical institution is unknown by the at least one patient, and wherein the at least one patient can place at least one additional bid if the at least one bid is not accepted; the at least one medical institution accepting the at least one bid from the at least one patient, wherein if more than one medical institution accepts the at least one bid, then the at least one patient chooses the at least one medical institution of their choice; the at least one patient receiving at least one bid from the at least one medical institution for the healthcare related service; and the at least one patient accepting the at least one bid from the at least one medical institution for the fertility service. In some embodiments, the method provides for the steps of: the at least one medical institution accepting the at least one patient's acceptance of the at least one bid, wherein upon acceptance of the at least one bid, the at least one medical institution becomes known to the at least one patient and the at least one patient paying an accepted bid price to the at least one medical institution.

In another embodiment there is a method of providing an electronic health cost adjustable marketplace, the method comprising the steps of: providing a first electronic device in communication with a server via a first communication network, the first electronic device having a computer readable storage medium storing one or more programs for execution by one or more processors, wherein the one or more programs has instructions for providing a cost adjustable marketplace application to a wired or wireless device, and wherein the first electronic device is accessed by at least one patient; providing a second electronic device in communication with the server via a second communication network, the second electronic device having a computer readable storage medium storing one or more programs for execution by one or more processors, wherein the one or more programs has instructions for providing a cost adjustable marketplace application to a wired or wireless device, and wherein the second electronic device is accessed by at least one medical institution; the at least one patient placing at least one bid via the first electronic device for a healthcare related service with the bid to be provided to the at least one medical institution, wherein the identity of the at least one medical institution is unknown by the at least one patient, and wherein the at least one patient can place at least one additional bid if the at least one bid is not accepted; the at least one medical institution accepting the at least one bid from the at least one patient, wherein if more than one medical institution accepts the at least one bid, then the at least one patient chooses the at least one medical institution of their choice; the at least one patient receiving at least one bid from the at least one medical institution for the healthcare related service; the at least one patient accepting the at least one bid from the at least one medical institution for the fertility service; the at least one medical institution accepting the at least one patient's acceptance of the at least one bid, wherein upon acceptance of the at least one bid, the at least one medical institution becomes known to the at least one patient; and

the at least one patient paying an accepted bid price to the at least one medical institution.

In yet another embodiment of the present invention there is a computer implemented system for providing an electronic health cost adjustable marketplace, the system having a processor based computing device capable of being connected to a network; a computer readable storage medium storing one or more programs for execution by the processor based computing device, wherein the one or more programs has instructions for providing a health based application to a wired or wireless device, the interactive medical information application having a database containing non-descriptive patient information; wherein the health based application enables at least one patient to find a medical professional within a predetermined vicinity, make a health based donation, applying for at least one medical treatment or a combination thereof.

In general, the present invention succeeds in conferring the following, and others not mentioned, benefits and objectives.

It is an object of the present invention to provide an application that facilitates medical based transactions.

It is an object of the present invention to provide an application that locates medical professionals for services.

It is an object of the present invention to provide an application enables donations to be made to a particular facility.

It is an object of the present invention to provide an application that creates a health exchange for medical services.

It is an object of the present invention to provide an application that creates a health exchange for medical treatments.

It is an object of the present invention to provide an application that increases the visibility of the health communities' needs.

It is an object of the present invention to provide an application that can be accessed and used by people seeking to both donate and receive medical or health related goods and services.

It is an object of the present invention to provide an application can be accessed from a variety of electronic based platforms and devices.

It is an object of the present invention to provide an application that allows for the creation of a virtual insurance card or payment system which allows immediate verification of benefits and payments to both providers and carriers.

### BRIEF DESCRIPTION OF THE DRAWINGS

FIG. 1 is a high level overview of an embodiment of the present invention.

FIG. 2 is a flowchart illustrating a match-making functionality of an embodiment of the present invention.

FIG. 3 is a flowchart illustrating an implementation of the fertility exchange.

FIG. 4 is a flowchart illustrating an implementation of a medical services module of an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations.

One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.”

Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s))” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O.

In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like.

The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like.

Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state.

The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST' s R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx.

Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices, such as other components of the may include temperature sensors and the like and may further be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation.

In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blu-ray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. The operating system may be one specifically optimized to be run on a mobile computing device, such as iOS, Android, Windows Phone, Tizen, Symbian, and/or the like.

An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C(++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components.

After a Domain Name System (DNS) resolution portion of an HTTP request is resolved to a particular information server, the information server resolves requests for information at specified locations on the controller of the present invention based on the remainder of the HTTP request. For example, a request such as “http://123.124.125.126/myInformation.html” might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Firefox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C(++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like.

The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network.

The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

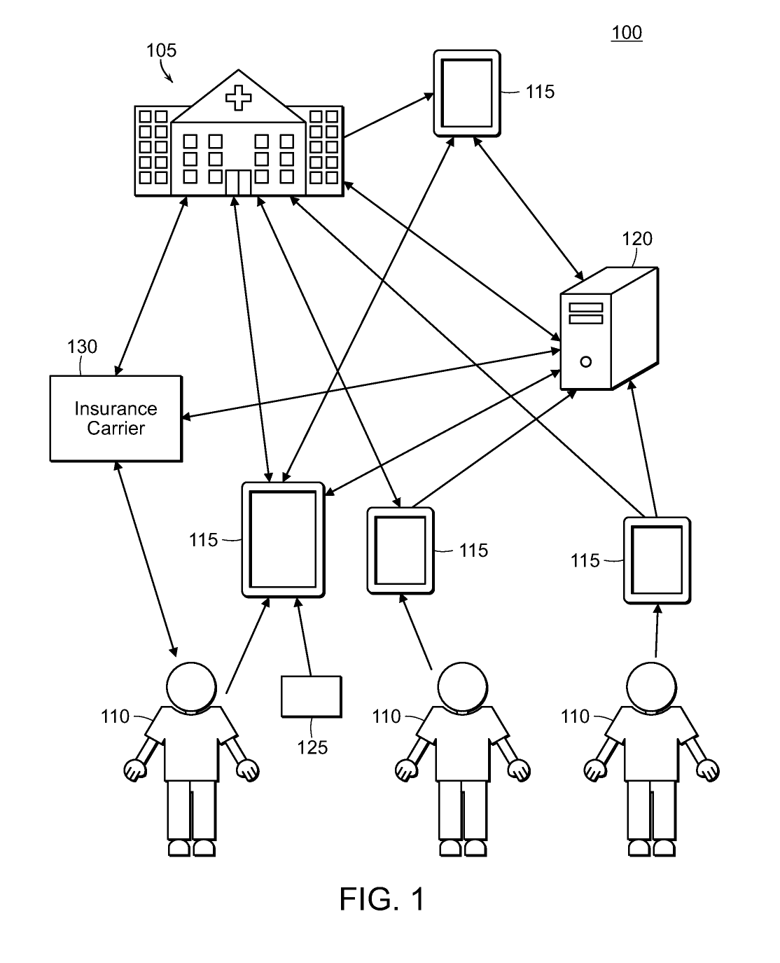

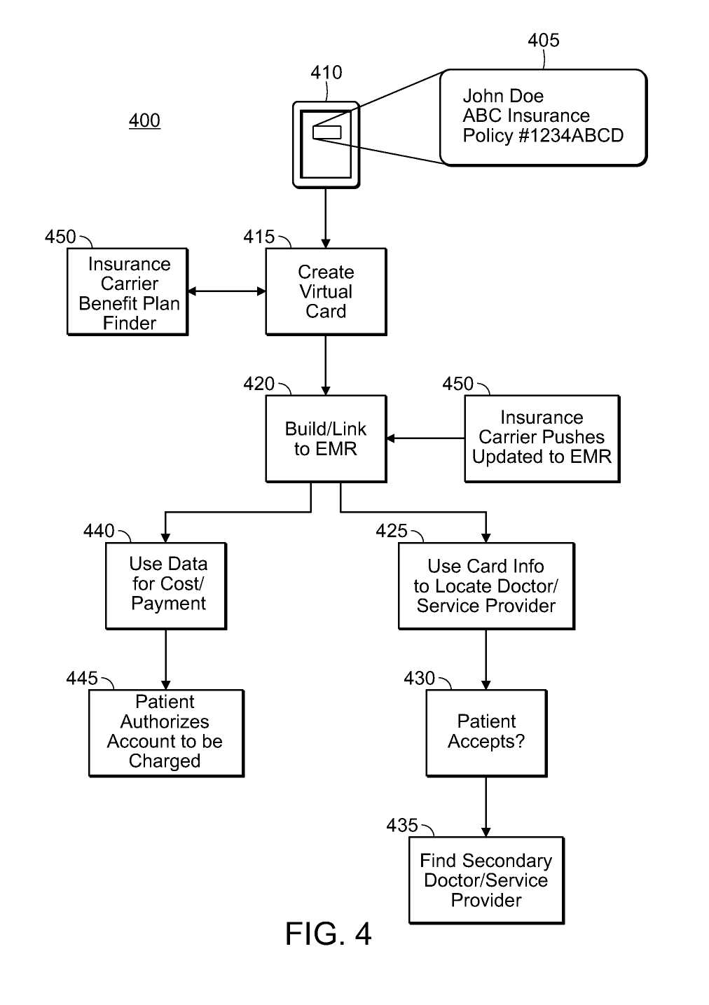

Referring now to FIG. 1, there is a high level overview of an embodiment of the present invention demonstrating an interrelationship between the various entities and system components associated with said system. The system 100 is generally comprised of at least one medical service provider 105, at least one user (patient) 110, an electronic device 115 being capable of connecting to a communications network, at least one insurance carrier 130, and at least one server 120. In some embodiments, user information 125 is input into the system via the electronic device 115 as further discussed in FIG. 4.

Typically, both a user 110 and a medical service provider 105 have access to an electronic device 115 that is capable of being coupled or otherwise communicatively coupled to a communications network such as the internet. The electronic device 115 may take any number of forms including but not limited to smart phones, tablets, desktop computers, lap top computers, PDAs, smart watches, head mounted displays, multimedia players, gaming systems, and the like.

Data and information exchanged through the system may be stored locally on the electronic device 115 as well as on one or more servers 120 configured to provide machine readable instructions for running an application, either mobile or web based, to allow the system to operate. The processors and memory comprising the server(s) 120 allow for this execution and storage of information. The information may be related to offering of medical services by the medical service provider, offers for donations (eggs, sperm, embryos, etc.) by a user or some combination thereof of such items and other related items not specifically mentioned herein.

As shown in FIG. 1, the system, as a whole, is interrelated in such a way that enables or facilitates communication between any of the entities or components including the medical service provider 105, user 110, electronic device 115, and server 120 and insurance carrier 130. In some instances, specific user data 125 such as medical insurance data may be capable of being captured and stored via the electronic device 115. This information may then be used or communicated to other components of the system as well as be placed in an electronic medical record (EMR) of the user 110.

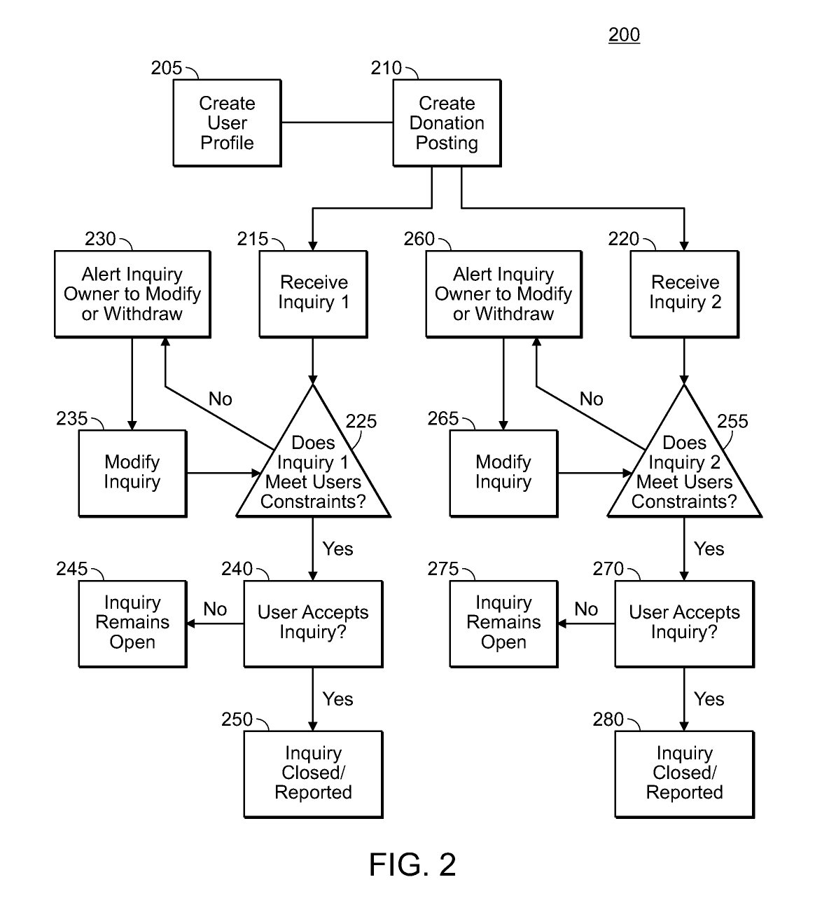

FIG. 2 illustrates one component of an embodiment of the present invention which entails the match-making functionality associated with the system. The match-making functionality is generally intended to pair potential donors/recipients/gestational carriers and surrogates, potential patients/medical service providers, donors/medical service providers, and the like.

In step 205, a user preferably creates a user profile for accessing and providing basic non-descript information about themselves such that the match-making process can proceed with facilitating quality matches. The information comprising the patient or user profile allows the user to remain anonymous while still receiving quality matches. General information that may be required to be collected as part of the profile may be age, gender, geographic location, race, height, weight, occupation, price range of services sought, and the like. Other information may be collected depending if the profile is established for an individual or medical service provider or other group. This allows others to view the profile, also anonymously, to see if they can be of assistance in being a match for the user. In some embodiments, an algorithm may automatically suggest or make matches based on this information.

In step 210, once the profile has been completed, a user can then create a donation or services posting. This posting may be visible to certain medical service providers, individuals, or other users or a combination thereof. The posting may be only viewable by entities within a particular geographic region or by those who offer or are offering certain services.

The user may then receive any number of inquiries or offers in response to their posting represented by “inquiry 1” and “inquiry 2” in FIG. 2. In step 215, the user receives inquiry 1 or a first inquiry from a prospective engager. In step 225, it is ascertained whether the inquiry meets the constraints, if any, placed by the user. In some instances, the inquiry may include a counter offer or other terms that may not coincide exactly with the posting. In other instances, such a communication would be filtered by the system before ever reaching the user.

If the inquiry is deficient in some form, then in step 230, the inquiry maker may be allowed to modify the inquiry or withdraw the inquiry from consideration. In some instances, the user may contact and facilitate a negotiation to arrive at a mutually agreeable term(s). In other instances, the inquiry is modified in step 235 to marry with the user constraints or desires.

In step 240, the user may then accept the inquiry, however, the user is not bound to accept simply because the inquiry or offer meets the specifications or constraints of the original posting. As shown in step 245, the user ultimately rejected the inquiry and the inquiry thus remains open and active for other offers or inquiries to be made. In step 250, the inquiry has been accepted and closed. In some instances, the original posting may be reopened and reposted depending on the nature of the transaction.

As noted above, the user may receive multiple inquiries within a predetermined time frame. In step 220, the user has received a second inquiry. This inquiry may have occurred before, during, or after the time the first inquiry was made. The inquiries may or may not be visible to the other inquirer and may result in a competitive “bidding war” for the desired donation. However, generally the process for dealing with each individual inquiry is relatively the same depending on the user's preferences.

In step 255, it is ascertained whether the second inquiry meets the constraints, if any, placed by the user. In some instances, the second inquiry may include a counter offer or other terms that may not coincide exactly with the posting. In other instances, such a communication would be filtered by the system before ever reaching the user.

If the second inquiry is deficient in some form, then in step 260, the second inquiry maker may be allowed to modify the second inquiry or withdraw the second inquiry from consideration. In some instances, the user may contact and facilitate a negotiation to arrive at a mutually agreeable term(s). In other instances, the second inquiry is modified in step 265 to marry with the user constraints or desires.

In step 270, the user may then accept the inquiry, however, the user is not bound to accept simply because the inquiry or offer meets the specifications or constraints of the original posting. As shown in step 275, the user ultimately rejected the inquiry and the inquiry thus remains open and active for other offers or inquiries to be made. In step 280, the inquiry has been accepted and closed. In some instances, the original posting may be reopened and reposted depending on the nature of the transaction.

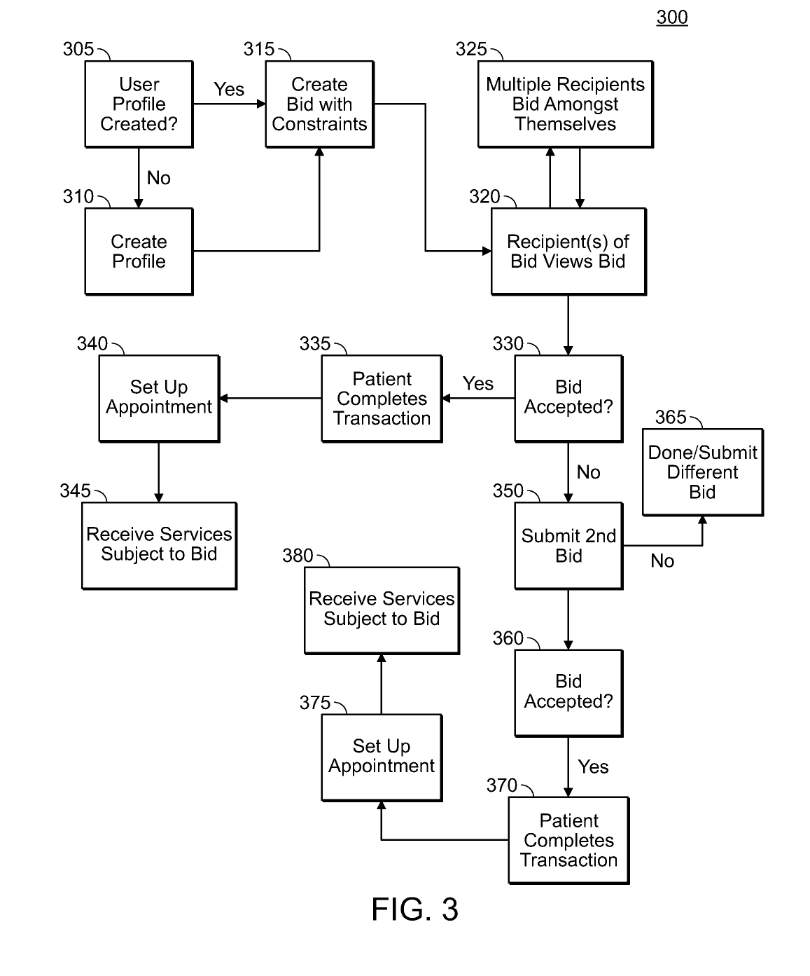

Referring now to FIG. 3, there is a flowchart providing an overview of the health exchange marketplace proposed by embodiments of the present invention. The health exchange marketplace may operate in conjunction with the match-making as described in FIG. 2, or may operate as a separate component within the system.

In step 305, the system check to see if the user is a first time user and if the user has a profile created. In the event the user has no profile, the user may be directed to step 310 to create a profile. If the user has an existing profile, the process proceeds step 315.

In step 310, a user preferably creates a user profile for accessing and providing basic non-descript information about themselves such that the health exchange can proceed with facilitating proper searches and offers from medical service providers. The information comprising the patient or user profile allows the user to remain anonymous while still receiving quality matches. General information that may be required to be collected as part of the profile may be age, gender, geographic location, race, height, weight, occupation, price range of services sought, and the like. Further, the medical service provider is able to remain anonymous as it reviews and places bids during the process. Only when, as described below, an agreement is reached is the identity of the parties revealed to one another.

In step 315, the user may create an open bid with constraints for a medical, surgical, dental, radiological, or other healthcare related services. In a preferred embodiment this may include but is not limited to fertility services. For example, the open bid may be for a fertility evaluation, fertility procedure, fertility medication, fertility doctor appointment, egg donation, gestational carrier service, fertility financing, or fertility laboratory procedure or any combination thereof. The open bid may contain details from the user created profile as well as other specific information as it relates to the particular service sought.

In step 320, the bid can be viewed by any number of entities preferably comprising medical service providers. Depending on the nature and services provided by the medical service provider and any user constraints, certain medical service providers may be precluded from accepting a particular bid.

In step 325, multiple bidders have placed bids to provide the same goods and services to the user. These bidders, or medical service providers, may then bid amongst themselves to appear more desirable to the user. There may be a ranking system or other algorithm that enables the medical service providers to be presented to the user in a particular fashion that favors one or more medical service providers over another.

In step 330, the open bid is either accepted by a medical service provider or no bids are placed. If the bid is accepted, the patient completes the transaction in step 335. This preferably entails paying for the medical service to be received as well as revealing to the user and the medical service provider the identities of each other. The user then sets up an appointment, in step 340, and the natural progression of receiving medical services takes over from that point as shown in step 345. Additionally, the user may be sent information regarding their payment as compared to the regional and national averages for a similar procedure as well as a cost savings from the health exchange.

In some instances, the bid will not be accepted. Thus, in step 350, the user may submit a second bid. This second bid may contain different variables in order to solicit a bid from a medical service provider.

In this instance, in step 360, the system checks to see if the bid has been accepted. If the bid is accepted, the patient completes the transaction in step 370. This preferably entails paying for the medical service to be received as well as revealing to the user and the medical service provider the identities of each other. The user then sets up an appointment, in step 375, and the natural progression of receiving medical services takes over from that point as shown in step 380. Additionally, the user may be sent information regarding their payment as compared to the regional and national averages for a similar procedure as well as a cost savings from the health exchange.

If the bid is not accepted, as shown in step 365, the user may be precluded from creating more bids within a certain time frame. In other embodiments, the user may be able to create another bid in an attempt to solicit offers or bids. The user may also have the option of knowing what the average price of the counter bid(s) is/are in the region he or she is seeking care in order to negotiate an acceptable bid for treatment or find a provider out of the region of care with a potentially lower counter-bid price. The user may also have the option of knowing what the lowest acceptable bid price is for the service desired and then accept that counter-bid offer.

In FIG. 4, there is a flowchart illustrating an implementation of a medical services module of an embodiment of the present invention. The method 400 begins in step 405 where a user provides information that is capable of being captured by an optical device such as a camera. The optical device may reside on an electronic device 410 as previously described in FIG. 1.

The information to be supplied may be a medical insurance card and which a representation of the front side and the back side may be captured by the optical device. This data may be captured individually (e.g. name, address, policy, etc.) or may capture the entire card at once.

In step 415, a virtual card is created. The virtual card will contain all the information as the physical card, but may have a different look or appearance. The virtual card may be used for many functions, some of which are described below. Alternatively, the virtual card may be used to find an insurance carrier benefit as shown in step 460. In one embodiment, this enables the information from the virtual card to be searched and compared to various carrier requirements put in place by the carrier or medical service provider, thereby enabling matches to found that the user may otherwise not know exist.

In step 420, the virtual card is used to link to or otherwise place the virtual card in an electronic medical record (EMR). This provides the information in the medical record where it can be accessed by any medical professional who may require the information whether the user has the information in or on their person.

In some embodiments, as shown in step 450, the insurance carrier may be able to push updates in policies, policy numbers, and the like directly to the EMR. This accurately provides up to date information in the EMR.

Once in the medical record, the virtual card may then be used to calculate the particular cost of a medical procedure or service as shown in step 440. This module may operate in conjunction with any of the other modules described herein to facilitate making and acceptance of offers, donations, etc. for medical materials and services. In step 445, the patient can then authorize that card to be used in conjunction with processing payments for the acceptance of medical services and the like.

Further, the information in the medical record may be used, as shown in step 425, to locate a particular doctor or service provider. For example, the system may be able to alert a user to the fact that a particular medical service provider who has bid on their open bid is not contained within their insurer's network and will therefore likely cost considerably more money. Further, location information can be used to quickly find the closest doctor or medical service provider in an area that accepts the user's insurance in the event of a medical emergency.

The user may accept the recommendation given in step 425 as shown in step 430 or may decide that they would like further recommendation(s) from the system as shown in step 435. The user may also be able to communicate with the insurance carrier to identify covered and non-covered benefits as well as posted or pending payments for services rendered step 450.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method of providing an electronic health cost adjustable marketplace, the method comprising the steps of:
providing a first electronic device in communication with a server via a first communication network, the first electronic device having a computer readable storage medium storing one or more programs for execution by one or more processors,
wherein the one or more programs has instructions for providing a cost adjustable marketplace application to a wired or wireless device, and
wherein the first electronic device is accessed by at least one patient;
providing a second electronic device in communication with the server via a second communication network, the second electronic device having a computer readable storage medium storing one or more programs for execution by one or more processors,
wherein the one or more programs has instructions for providing a cost adjustable marketplace application to a wired or wireless device, and
wherein the second electronic device is accessed by at least one medical institution;
the at least one patient placing at least one bid via the first electronic device for a healthcare related service with the bid to be provided to the at least one medical institution,
wherein the identity of the at least one medical institution is unknown by the at least one patient, and
wherein the at least one patient can place at least one additional bid if the at least one bid is not accepted;
the at least one medical institution accepting the at least one bid from the at least one patient,
wherein if more than one medical institution accepts the at least one bid, then the at least one patients is able to choose the at least one medical institution of their choice;
the at least one patient receiving at least one bid from the at least one medical institution for the healthcare related service; and
the at least one patient accepting the at least one bid from the at least one medical institution for the fertility service.

2. The method of claim 1 further comprising the step of:
the at least one medical institution accepting the at least one patient's acceptance of the at least one bid,
wherein upon acceptance of the at least one bid, the at least one medical institution becomes known to the at least one patient.

3. The method of claim 2 further comprising the step of:
the at least one patient paying an accepted bid price to the at least one medical institution.

4. The method of claim 1 wherein the fertility service is at least one of a fertility procedure, fertility medication, fertility doctor appointment, egg donation, gestational carrier service, fertility financing, or fertility laboratory procedure or any combination thereof.

5. The method of claim 1 wherein each bidding institution is ranked according to their respective bids.

6. The method of claim 1 wherein the at least one bid must be accepted within a predetermined time threshold.

7. The method of claim 1 wherein multiple services may be bundled into a single bid by the at least one patient.

8. A method of providing an electronic health cost adjustable marketplace, the method comprising the steps of:
providing a first electronic device in communication with a server via a first communication network, the first electronic device having a computer readable storage medium storing one or more programs for execution by one or more processors,
wherein the one or more programs has instructions for providing a cost adjustable marketplace application to a wired or wireless device, and
wherein the first electronic device is accessed by at least one patient;
providing a second electronic device in communication with the server via a second communication network, the second electronic device having a computer readable storage medium storing one or more programs for execution by one or more processors,
wherein the one or more programs has instructions for providing a cost adjustable marketplace application to a wired or wireless device, and
wherein the second electronic device is accessed by at least one medical institution;
the at least one patient placing at least one bid via the first electronic device for a healthcare related service with the bid to be provided to the at least one medical institution,
wherein the identity of the at least one medical institution is unknown by the at least one patient, and
wherein the at least one patient can place at least one additional bid if the at least one bid is not accepted;
the at least one medical institution accepting the at least one bid from the at least one patient,
wherein if more than one medical institution accepts the at least one bid, then the at least one patient is able to choose the at least one medical institution of their choice;
the at least one patient receiving at least one bid from the at least one medical institution for the fertility service;
the at least one patient accepting the at least one bid from the at least one medical institution for the fertility service;
the at least one medical institution accepting the at least one patient's acceptance of the at least one bid,
wherein upon acceptance of the at least one bid, the at least one medical institution becomes known to the at least one patient; and
the at least one patient paying an accepted bid price to the at least one medical institution.

9. The method of claim 8, wherein only bids received from the at least one medical institution within a predetermined time period are considered for the contract.

10. The method of claim 9, wherein the bids received from the at least one medical institution are capable of being changed before acceptance by the at least one patient.

11. A computer implemented system for providing an electronic health cost adjustable marketplace, the system comprising:
a processor based computing device capable of being connected to a network;
a computer readable storage medium storing one or more programs for execution by the processor based computing device,
wherein the one or more programs has instructions for providing a health based application to a wired or wireless device,
the interactive medical information application having a database containing non-descriptive patient information;
wherein the health based application enables at least one patient to find a medical professional within a predetermined vicinity, make a health based donation, applying for at least one medical treatment or a combination thereof.

12. A method of providing health related services, the method comprising:
providing a first electronic device in communication with a server via a first communication network, the first electronic device having a computer readable storage medium storing one or more programs for execution by one or more processors,
wherein the one or more programs has instructions for providing a health based marketplace application to a wired or wireless device, and
wherein the first electronic device is accessed by at least one patient;
providing a second electronic device in communication with the server via a second communication network, the second electronic device having a computer readable storage medium storing one or more programs for execution by one or more processors,
wherein the one or more programs has instructions for providing a health based marketplace application to a wired or wireless device, and
wherein the second electronic device is accessed by at least one medical institution;
the at least one patient placing non-identifying information to be provided to the at least one medical institution,
wherein the identity of the at least one medical institution is unknown by the at least one patient;
the at least one medical institution viewing the non-identifying information from the at least one patient;
the at least one patient receiving at least one communication from the at least one medical institution; and
the at least one patient taking an action in response to the at least one communication from the at least one medical institution.

13. The method of claim 12 wherein the non-identifying information is information pertaining to at least one fertility treatment.

14. The method of claim 12 wherein the non-identifying information is information pertaining to a fertility based donation.

15. The method of claim 12 wherein the non-identifying information is patient information seeking a doctor within a predetermined vicinity.
